(19) United States
(12) Patent Application Publication
(10) Pub. No.: US 2011/0103987 A1
(43) Pub. Date: May 5, 2011

(54) PUMP SYSTEM

(75) Inventors: Vasanth Srinivasa Kothnur, Clifton Park, NY (US); David Deloyd Anderson, Glenville, NY (US); Farshad Ghasripoor, Glenville, NY (US); Hrishikesh Vishvas Deo, Saratoga Springs, NY (US); Michael V. Drexel, Delanson, NY (US); Thomas Lowell Steen, Ballston Spa, NY (US)

(73) Assignee: GENERAL ELECTRIC COMPANY, SCHENECTADY, NY (US)

(21) Appl. No.: 12/612,005

(22) Filed: Nov. 4, 2009

(51) Int. Cl. F04C 2/16; B23P 11/00

(52) U.S. Cl. 418/1; 418/202; 29/888.023

(57) ABSTRACT

The present invention provides a pump system comprising a bearing housing coupled to a pump liner, the pump liner defining a fluid conduit, the pump liner comprising a fluid inlet and a fluid outlet; and at least one rotor having a first rotor portion and a second rotor portion, the first rotor portion being disposed within the fluid conduit and the second rotor portion being disposed within the bearing housing; the first rotor portion comprising a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit. The new pump systems rely on a dynamic restriction to reduce the need for mechanical seals between bearing housings and raw process fluid.

### BACKGROUND OF THE INVENTION

The embodiments disclosed herein relate generally to pumps and pump systems, and more particularly to process fluid management within pumps.

Screw pumps are rotary, positive displacement pumps that may use two or more screws to transport high or low viscosity fluids or fluid mixtures along an axis. Twin-screw pumps may have two intermeshing counter-rotating screws which may at times be referred to as rotors disposed within a fluid conduit. Cavities for pumping are formed between the intermeshing screws and a pump liner or pump casing. As the screws rotate, the cavities and the fluid within the cavities are transported from an inlet to an outlet of the pump. In some applications, twin-screw pumps are used to aid in the extraction of oil and gas from on-shore and sub-sea wells. Twin-screw pumps may lower the back-pressure on a hydrocarbon reservoir and thereby enable greater total recovery from the reservoir.

In conventional screw pumps, mechanical seals are used to isolate components used to drive and control a pump screw, from portions of the pump screw which contact a fluid being processed by the pump (the process fluid). Thus, a pump screw will be disposed partially within a bearing housing isolated from the process fluid and partially within a process fluid conduit. This presents a dual challenge, as it is necessary to design a barrier which prevents process fluid from entering the bearing housing from the process fluid conduit, and which prevents lubricating fluid present within the bearing housing from being lost to the process fluid stream within the process fluid conduit. Mechanical seals, though critical to the performance of a variety of screw pumps, are susceptible to wear and tear during the operation of the screw pump, and present design and operational complexities.

Therefore, there is a need for a pump system with reduced reliance on mechanical seals, while at the same time providing robust pumping capabilities.

### BRIEF DESCRIPTION OF THE INVENTION

In one embodiment, a pump system comprises, a bearing housing coupled to a pump liner, the pump liner defining a fluid conduit, the pump liner comprising a fluid inlet and a fluid outlet; and at least one rotor having a first rotor portion and a second rotor portion, the first rotor portion being disposed within the fluid conduit and the second rotor portion being disposed within the bearing housing; the first rotor portion comprising a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit.

In another embodiment, a method of manufacture comprises providing a bearing housing coupled to a pump liner, the pump liner defining a fluid conduit, the pump liner comprising a fluid inlet and a fluid outlet; and disposing at least one rotor having a first rotor portion and a second rotor portion within the fluid conduit and the bearing housing such that the first rotor portion is disposed within the fluid conduit and the second rotor portion is disposed within the bearing housing; wherein the first rotor portion comprises a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit.

In yet another embodiment, a method of pumping a fluid comprises introducing a process fluid into a pump system via a fluid inlet of the pump system and removing the process fluid from a fluid outlet of the pump system, said pump system comprising a bearing housing coupled to a pump liner, the pump liner defining a fluid conduit, the pump liner comprising the fluid inlet and the fluid outlet; and at least one rotor having a first rotor portion and a second rotor portion, the first rotor portion being disposed within the fluid conduit and the second rotor portion being disposed within the bearing housing; the first rotor portion comprising a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit.

Technical effects of the invention include reduced wear and maintenance of pump system components. Further, the embodiments also lead to simplified assembly and maintenance of pump systems by eliminating dedicated sealing systems and components. Moreover, the disclosed embodiments may improve pump system performance by managing the pressures throughout the pump system to control fluid flow without the need for additional sealing components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a pump system and a production platform in accordance with an embodiment of the present invention;

FIG. 2 is a schematic diagram of a pump system in accordance with an embodiment of the present invention;

FIG. 3 is a detailed perspective view of a pump system, in accordance with an embodiment of the present invention;

FIG. 4 is a detailed exploded view of a pump system, in accordance with an embodiment of the present invention;

FIG. 5 is a detailed side view of components within a pump system, including rotors in accordance with an embodiment of the present invention;

FIG. 6 is a detailed perspective view of certain components within a pump system, including rotors in accordance with an embodiment of the present invention;

FIG. 7 is a detailed perspective view of a rotor in accordance with an embodiment of the present invention;

FIG. 8 is a detailed perspective view of a rotor in accordance with an embodiment of the present invention; and

FIG. 9 is a detailed perspective view of a rotor in accordance with an embodiment of the present invention.

### DETAILED DESCRIPTION OF THE INVENTION

One or more specific embodiments of the present invention are described herein. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

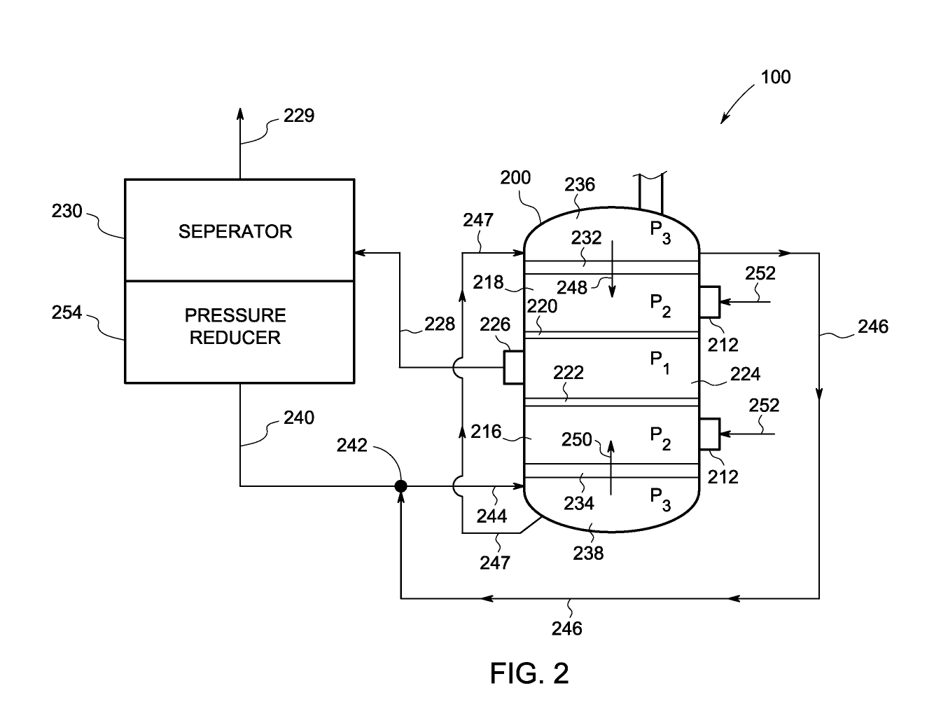

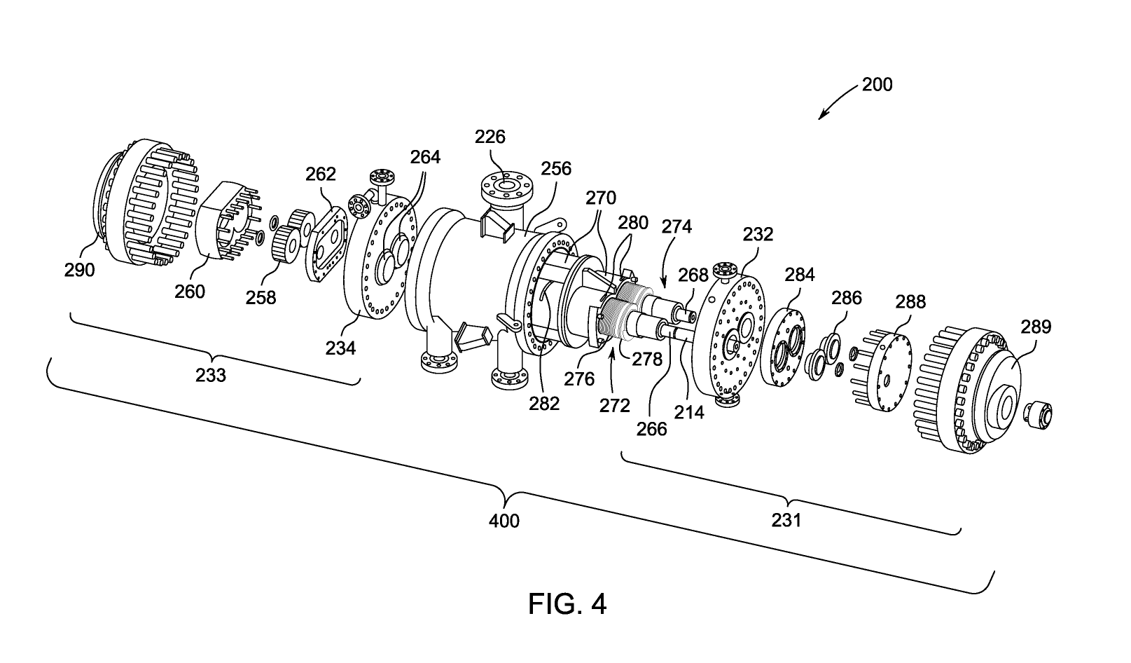

As used herein, the term “pump system” embraces both isolated pumps, for example the twin screw pump 200 shown in FIG. 4, as well as pumps comprised within larger systems, for example the system depicted in FIG. 2 in which a pump 200 is comprised within a larger system 100, the larger system 100 being at times herein referred to as a “pump system” and comprising the pump 200, a separator 230, a pressure reducer 254, and various fluid conduits external to the pump 200.

Embodiments of the invention described herein address the noted shortcomings of state of the art pump systems. In particular, the pump systems provided by the present invention reduce reliance on mechanical seals, and as a result the pump systems provided by the present invention offer opportunities for greater reliability and cost savings relative to pump systems known in the art. As is discussed in detail herein, reduced reliance on mechanical seals is achieved through the use of dynamic restriction as an alternative to mechanical seals, to control and bias fluid flow at various locations within the pump system. As will be appreciated by those of ordinary skill in the art, the elimination of the mechanical seals may help in reducing both the complexity and frequency of pump system maintenance.

In one embodiment, a pump system comprises, a bearing housing coupled to a pump liner, the pump liner defining a fluid conduit, the pump liner comprising a fluid inlet and a fluid outlet; and at least one rotor having a first rotor portion and a second rotor portion, the first rotor portion being disposed within the fluid conduit and the second rotor portion being disposed within the bearing housing; the first rotor portion comprising a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit. It is this first conveying stage which provides a dynamic restriction adjacent to the bearing housing when the pump is operation which restricts the flow of fluid from the fluid conduit defined by the pump liner into the bearing housing. With respect to the first conveying stage the term “adjacent to the bearing housing” means that there is no intervening mechanical seal between first conveying stage and the bearing housing. Typically, a mechanical seal, for example, a face seal or a lip seal, is used to prevent the passage of fluid from the interior of the pump liner defining the fluid conduit into the bearing housing, and also to prevent the loss of fluid from the bearing housing into the fluid conduit defined by the pump liner.

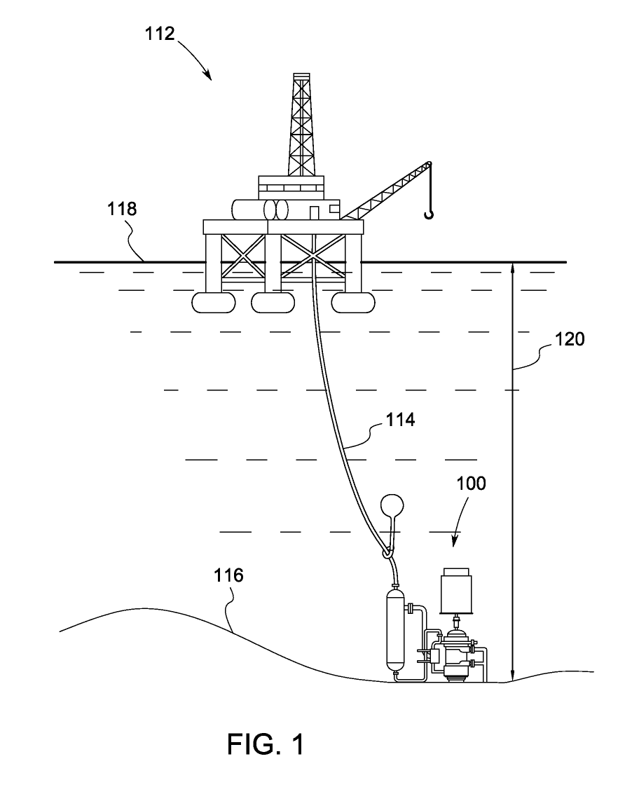

FIG. 1 is a schematic diagram of a pump system 100 that may be provided with a production platform 112 to pump a fluid for processing, storage and/or transport. As depicted, the pump system 100 may be connected to the production platform 112 via a conduit or riser 114 that may be used to route a process fluid to the platform. The process fluid may be a multiphase fluid, such as raw petroleum from a sub-sea source comprising liquid phase crude oil, liquid phase water, a gas phase comprising low molecular weight hydrocarbons and hydrogen sulfide, dissolved solids such as sodium chloride, and undissolved particulate solids such as sand. In addition, the pump system 100 may be located on a subsurface floor 116, wherein the pump system 100 pumps the process fluid to a production platform on the surface 118. As depicted, the pump system 100 may be located a distance 120 from the production platform 112, wherein the pump is used to create the pressure and force needed to pump the process fluid to the surface 118. In another embodiment, the pump system 100 may be located in a factory or a chemical plant and may be configured to direct a process fluid to holding tanks or other structures for processing or storage. In the illustrated example, the pump system 100 may be useful during the extraction of oil and/or gas from sub-sea wells to reduce back pressure on the deposit and assist in the extraction of the oil and/or gas from the deposit.

FIG. 2 is a schematic diagram of a pump system 100 including conduits 229, 240, 244, 246 and 247 that are used for fluid communication between the various components of the pump system 100. The pump system 100 comprises a pump 200 having fluid inlets 212 which direct the process fluid inlet flows 252 to inlet chambers 216 and 218. The inlet chambers 216 and 218 are configured to receive process fluid and are isolated from a fluid outlet chamber 224 by bulkhead separators 220 and 222. The bulkhead separators 220 and 222 enable the management of pressure within and between the respective chambers. Inlet chambers 216 and 218 are separated from upper end chamber 236 and lower end chamber 238 by the upper radial bearing flange 232 and lower radial bearing flange 234 respectively. Upper end chamber 236 and lower end chamber 238 are at times herein referred to as bearing housings. The outlet chamber 224 is configured to direct the process fluid out through the fluid outlet 226 as process fluid outflow 228. In the embodiment shown, the process fluid outflow 228 is directed to a separator 230. Passing the process fluid outflow 228 through the separator 230 may help in reducing amount of particulates present within the process fluid, the number of phases present within the process fluid, and/or the overall level of undesirable contaminants within the process fluid. The separator 230 may be configured to direct a portion of the separated process fluid downstream via conduit 229 while directing another portion of the separated process fluid via conduit 240 for recirculation through various components of the pump system.

Still referring to FIG. 2, the bathers, including upper and lower radial bearing flanges 232 and 234, as well as bulkhead separators 220 and 222, enable the inlet chambers 216 and 218 to be separated from the outlet and end chambers, thereby enabling the management of both fluid flow and pressure. The upper and lower end chambers 236 and 238 may each contain pump bearings, to enable smooth rotation of the rotors (not shown in figure) within the pump 200. In certain embodiments, pump bearings may be lubricated by recirculated process fluids. In one embodiment, the pump 200 comprises a bearing (not shown) housed within at least one of the upper end chamber 236 and lower end chamber 238, which bearing supports a rotor (not shown) and allows the rotor to rotate. A layer of lubricant separates the rotor from its supporting bearing. In one embodiment, the lubricant used is the process fluid recirculated from the separator 230.

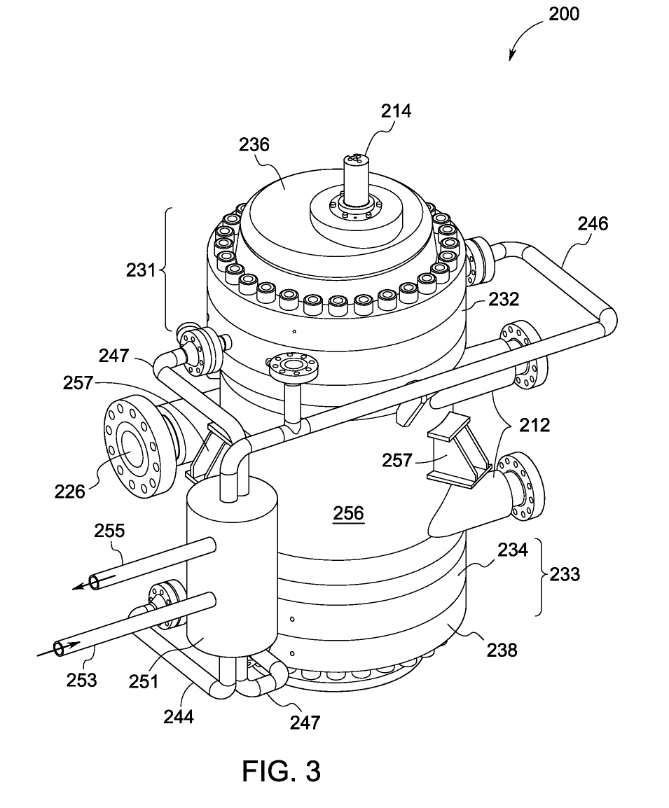

In various embodiments, the present invention provides a pump system comprising a twin-screw pump comprising two rotors that intermesh within a fluid conduit to convey a process fluid. One of the rotors may be coupled to a driving shaft 214 (FIG. 3), which may be coupled to a motor (not shown in figure). The motor and the driving shaft 214 produce a rotational output used to drive a driving rotor that may coupled, via timing gears to second rotor referred to as a driven rotor, thereby producing the necessary pressure and force to direct the process fluid downstream. In addition to transferring force and power from the driving rotor to the driven rotor, the timing gears may be used in various embodiments of the invention to crush particulates within process fluid used to lubricate the timing gears, as wherein process fluid is directed from a separator 230 (FIG. 2) through conduits 240 (FIG. 2) and 244 (FIG. 2) to lower end chamber 238 (FIG. 2) in which is disposed a set of timing gears. After passing through the gears the process fluid may be routed to lubricate other components within the pump system. Thus, in various embodiments, the timing gears serve not only to transfer mechanical energy between the rotors, but to also pump the lubricating fluid in contact with the timing gears, and to grind particulate matter in the lubricating fluid to an acceptable size for lubrication and wear avoidance. This feature may be of particular importance when process fluid is used as a lubricating fluid in various components of the pump system.

Referring to FIG. 2, the separated process fluid may flow via conduit 240 into the joint 242, wherein the combined flow from conduits 240 and 246 passes through conduit 244 into the lower end chamber 238. As mentioned, the lower end chamber 238 may include a set of timing gears which are lubricated by the process fluid entering the lower end chamber 238 via fluid conduit 244. The process fluid entering the lower end chamber 238 via fluid conduit 244 may be used to lubricate bearings and other components within the lower end chamber 238. Further, the process fluid may also be routed via the fluid conduit 247 to the upper end chamber 236 where the process fluid is directed to the bearings and other components located within the upper end chamber 236. A portion of the process fluid entering upper end chamber 236 may be directed via fluid conduit 246 and joint 242, to join the separated process fluid from conduit 240. Accordingly, the joining of flows from conduits 240 and 246 may be considered a makeup or re-circulation flow within a process fluid recirculation network.

Referring to FIG. 2, the upper radial bearing flange 232 and lower radial bearing flange 234 serve as barriers between the inlet chambers 216 and 218 and upper end chamber 236 and lower end chamber 238 respectively, and may be configured such that a portion of the process fluid (shown as leaks 248 and 250) may traverse the barriers and pass from either the lower end chamber 238 into inlet chamber 216 or from the upper end chamber 236 into inlet chamber 218. Leaks 248 and 250 further shield the components of the upper end chamber 236 and lower end chamber 238 from contact with untreated process fluid. Untreated process fluid is, for example, a multiphase process fluid entering the pump system via fluid inlets 212. Leaks 248 and 250 in the bathers 232 and 234 may improve the flow of process fluid within inlet chambers 216 and 218, and outlet chamber 224 by dilution of the raw process fluid thereby reducing both the concentration and size of particulates present in the conveying sections of the pump system. It should be stressed that pump system configurations lacking inputs of treated process fluid such as leaks 248 and 250, may be subject to the settling of raw process fluid particulates within inlet chambers 216 and 218, thereby impairing fluid flow between the inlet chambers 216 and 218 and outlet chamber 224. Further, the settling and/or buildup of particulates within the inlet chambers may cause breakdowns and increase the frequency of pump system shut down for maintenance. Those of ordinary skill in the art will appreciate that the amount of treated process fluid recirculated through the pump system may be adjusted as required depending on the nature of the raw process fluid.

Referring to FIG. 2, the pump system 100 may also include a pressure reducer 254 configured to be a part of the fluid flow path from the separator 230 to the lower end chamber 238. As illustrated, the pressure reducer 254 may be coupled to the separator 230, wherein the pressure reducer 254 enables a degree of pressure management within the treated process fluid recirculation network. Pressures within pump 200 are managed in order to control fluid flow within the pump. For example, the pressure within the outlet chamber 224, P₁, may be significantly greater than the pressure within the inlet chambers 216 and 218, P₂. In the case of a twin screw pump, this difference in pressure between P₂ and P₁, is caused by the pumping action of the twin screws. In addition, the pressure within the upper and lower end chambers 236 and 238, P₃, may be slightly greater than the pressure within the inlet chambers 216 and 218, P₂. This pressure difference between P₃ and P₂ may contribute to leaks 248 and 250. The pressure P₁ may be significantly greater than the pressure P₃, causing a need for the pressure reducer 254 to be located between the separator 230 and upper and lower end chambers 236 and 238. Separator 230, pressure reducer 254, upper and lower end chambers 236 and 238, joint 242, and fluid conduits 240, 244, 247 and 246 form part of the treated process fluid recirculation network illustrated in FIG. 2. The pressure reducer 254 may be of any suitable type as known to those of ordinary skill in the art.

FIG. 3 is a detailed perspective view of an embodiment of a pump system provided by the present invention which is a twin-screw pump 200. In the embodiment shown in FIG. 3, the twin-screw pump 200 includes upper end chamber 236 and lower end chamber 238. A driving shaft 214 is configured to enter the upper end chamber 236 to power the rotors (not shown in figure) of the twin-screw pump. In addition, the upper end chamber 236 is separated from the inlet chamber 218 (FIG. 2) of the pump by upper radial bearing flange 232. The section of the twin-screw pump 200 including the upper end chamber 236 and the upper radial bearing flange 232 and components contained therein may at times herein be referred to as the upper bearing housing 231. Similarly, the lower end chamber 238 is separated from fluid inlet chamber 216 (FIG. 2) by lower radial bearing flange 234. The section of the twin-screw pump 200 including the lower end chamber 238 and the lower radial bearing flange 234 and components contained therein may at times herein be referred to as the lower bearing housing 233. The upper and lower radial bearing flanges 232 and 234 are each coupled to a central pump casing cover 256 which encompasses the pump liner (not indicated in FIG. 3), inlet chambers 216 and 218 (not indicated in FIG. 3), as well as the outlet chamber 224 (not indicated in FIG. 3). The inlet chambers 216 and 218 may be coupled to fluid inlets 212 which accept, for example, a multiphase process fluid from a sub-sea well or other fluid supply unit. In certain embodiments, the fluid inlets 212 may be tangentially located with respect to the cylindrical central pump casing cover. Accordingly, the fluid inlets 212 are configured to create swirling and or turbulence of the raw process fluid entering the pump system via fluid inlets 212. In such embodiments, a pump fluid inlet tangentially located with respect to the cylindrical central pump casing cover is said to be configured to produce a tangential flow of a process fluid within a pump inlet chamber. Such agitation of the process fluid as it enters the pump system may act to prevent settling and buildup of particulates in the inlet chambers 216 and 218. The fluid outlet 226 is coupled to the outlet chamber 224 (not indicated in FIG. 3) and may be configured to direct the process fluid to the separator 230 (FIG. 2). Further, fluid conduits, including fluid conduits 244, 246 and 247 may be configured to direct treated process fluid throughout the twin-screw pump 200 to lubricate pump components. In the embodiment shown in FIG. 3 a heat exchanger 251 is used to remove heat from treated process fluid in the treated process fluid recirculation network and aids in controlling the operating temperature within the pump system. Heat exchanger 251 comprises a heat exchanger fluid inlet 253 and a heat exchanger fluid outlet 255. Mounts 257 may be used to secure the pump to a larger structure.

FIG. 4 is a detailed exploded view 400 of a twin-screw pump 200 provided by the present invention. As depicted, the twin-screw pump 200 comprises upper and lower bearing housings 231 and 233 (also referred to as end chambers 236 and 238) separated by a central portion of the pump defined by central pump casing cover 256. A pair of timing gears 258 may be located inside a gear housing 260 which is a component of the lower bearing housing 233. As previously discussed, the timing gears transfer mechanical energy from the driving rotor 266 to the driven rotor 268, and further the timing gears may also be configured to grind particulate matter present in the treated process fluid. Other components of the lower bearing housing 233 include a gear plate 262 coupled to the gear housing 260 and lower radial bearing flange 234. In certain embodiments, rotor shrouds 264 may be coupled to the lower radial bearing flange 234. The rotor shrouds 264 may be configured in a particular geometry and with suitable rotor clearance to enable a controlled leakage of treated process fluid from the lower bearing housing 233 into the fluid conduit defined by pump liner 270. In certain embodiments (not shown in figure), the upper bearing housing 231 may also include rotor shrouds to enable a controlled leakage of treated process fluid into the fluid conduit defined by pump liner 270.

Referring to FIG. 4, as noted, the driving shaft 214 may be coupled to or form an integral part of the driving rotor 266 which is configured to drive a driven rotor 268. Accordingly, the driven rotor 268 is mechanically driven by the rotation of the timing gears 258 which is initiated by the rotational output from the driving rotor 266. The driving rotor is coupled to or is integral to driving shaft 214 which in turn may be coupled to a motor (not indicated in FIG. 4). The rotors are disposed both within the fluid conduit defined by pump liner 270 and also within the upper bearing housing 231 and lower bearing housing 233. The driving rotor 266 and driven rotor 268 each comprise a first rotor portion 272 which is disposed within the fluid conduit defined by the pump liner 270. Each of the rotors further comprises a second rotor portion 274 at each end of the rotor which is disposed within the upper bearing housing 231 and lower bearing housing 233 respectively. In embodiments which include rotor shrouds 264, the rotors 266 and 268 are disposed within the rotor shrouds 264. Typically, the driving rotor 266 and driven rotor 268 are intermeshing and may be rotated to drive a fluid through the twin-screw pump 200. As noted, the first rotor portion is disposed within the fluid conduit defined by pump liner 270 and comprises a first conveying stage 278 adjacent to the upper bearing housing 231, and a second conveying stage 276 adjacent to the first conveying stage 278. The first conveying stage 278 is configured to convey fluid from the bearing housing into the fluid conduit. This means that the first conveying stage 278 conveys fluid away from the upper bearing housing 231 and toward the fluid outlet 226. The first and second conveying stages 278 and 276 may be configured to convey a fluid in opposite directions, or may be configured to convey a fluid in the same direction within the fluid conduit defined by pump liner 270. Those of ordinary skill in the art will appreciate that the portion of the rotors adjacent to the lower bearing housing 233 (that rotor portion not being indicated in FIG. 4) may also comprise a first conveying stage located within the fluid conduit defined by pump liner 270 said first conveying stage being adjacent to the lower bearing housing 233, said first conveying stage being configured to convey fluid from the lower bearing housing into the fluid conduit. Thus, the first conveying stage 278 is configured to convey a fluid from the bearing housings 231 and 233 into the fluid conduit defined by the pump liner 270 and out through a fluid outlet such as fluid outlet 226. The pump liner 270 may be disposed around the rotors 266 and 268 and may flex to prevent binding of the pump liner 270 to the rotors during operation. The pump liner 270 may include a fluid inlet 280 which may be configured to provide process fluid to a portion of the rotor disposed within the pump liner 270. Further, the pump liner 270 may also include fluid outlet 282 through which process fluid is removed from the fluid conduit defined by the pump liner 270 and is thereafter directed to fluid outlet 226. The rotors 266 and 268 include shafts that pass through openings in the upper radial bearing flange 232, thrust bearing plate 284 and thrust bearing collars 286. An upper thrust bearing plate 288 may couple to the thrust bearing plate 284, thereby encompassing the thrust bearing collars 286 and the ends of the rotors 266 and 268. The thrust bearing plate 284, thrust bearing collars 286 and thrust bearing plate 288 constitute components of the upper bearing housing. The lower bearing housing 233 is similarly configured but accommodates the timing gears 258. Each of the upper bearing housing 231 and lower bearing housing 233 is further defined by an upper bearing housing sealing member 289 and a lower bearing housing sealing member 290.

As noted, the conveying stages (276 and 278, FIG. 4) of the rotors of pumps provided by the present invention are disposed within the pump liner (270 FIG. 4). As will be appreciated by those of ordinary skill in the art, sufficient clearance must exist between the rotor and the inner surface of the pump liner. The clearance may be large enough to disallow the rotor from coming in physical contact with the pump liner thus avoiding damage to the pump liner due to the rotating motion of the rotor. At the same time, a large gap between the rotor and the inner surface of the pump liner is undesirable. In one embodiment, the clearance between the rotor and an inner surface of the pump liner is in a range from about 5 thousandths of an inch to about 10 thousandths of an inch. In another embodiment, the clearance between the rotor and an inner surface of the pump liner is in a range from about 6 thousandths of an inch to about 9 thousandths of an inch. In yet another embodiment, the clearance between the rotor and an inner surface of the pump liner is in a range from about 7 thousandths of an inch to about 8 thousandths of an inch. In one embodiment, the configuration of the first conveying stage and second conveying stage in combination with the low clearance between the rotor and the inner surface of the pump liner may function as a shaft seal.

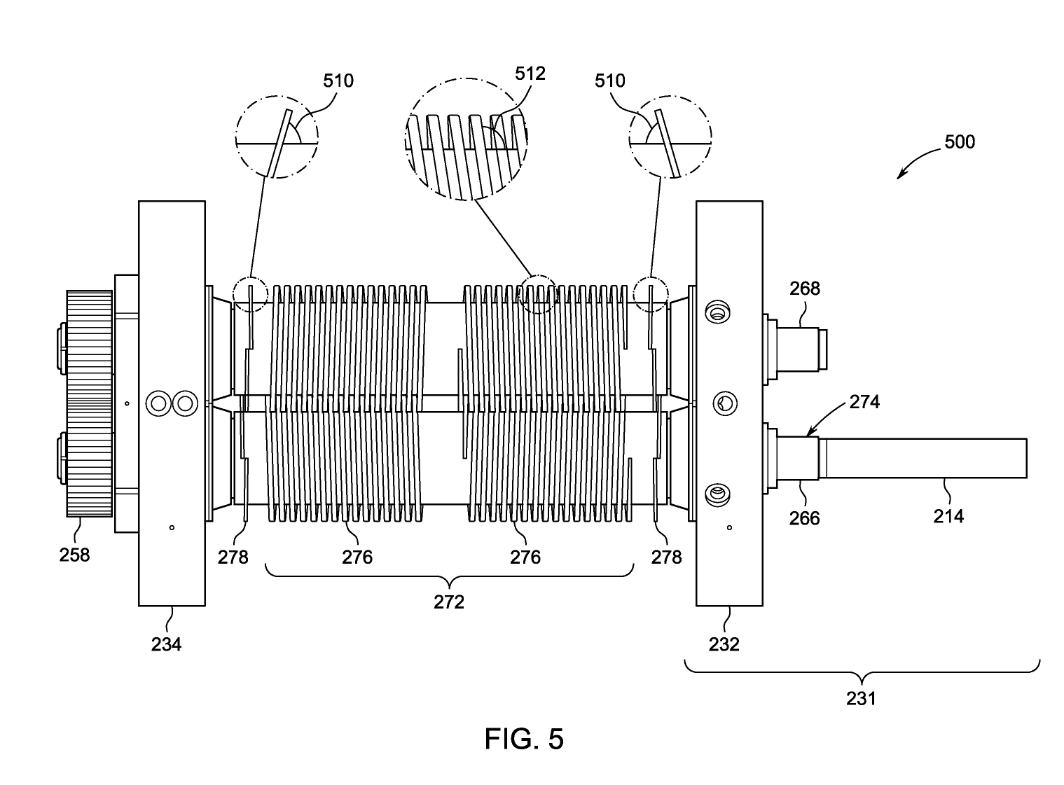

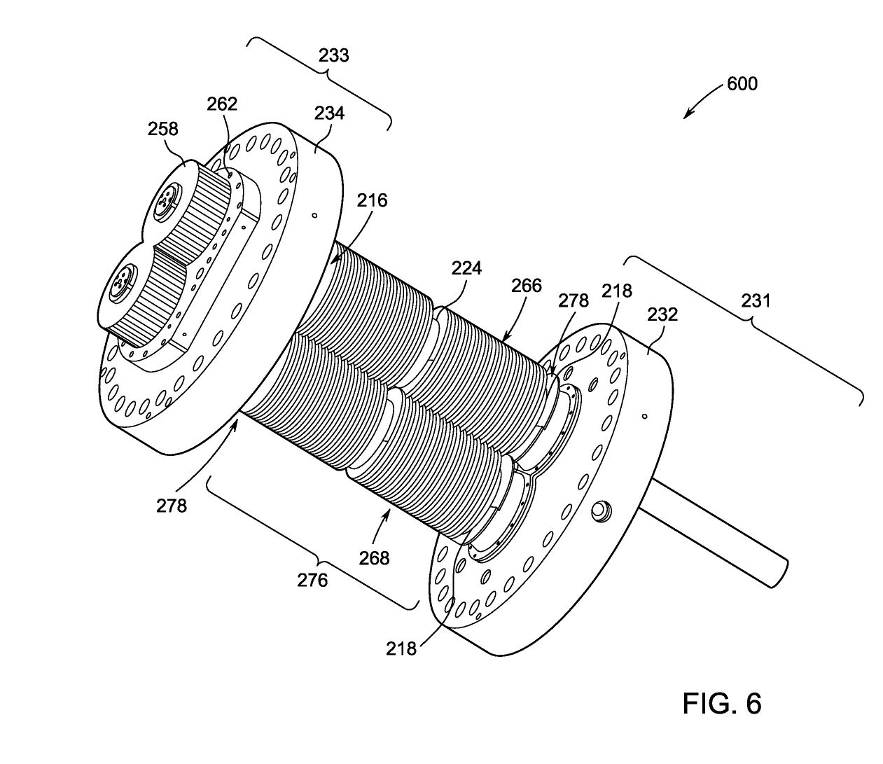

FIG. 5 is a detailed side view 500 of an embodiment of the present invention configured for use in a twin-screw pump 200. As depicted, the rotors 266 and 268 may be coupled to timing gears 258. Timing gears 258 are configured to intermesh and couple the mechanical output of the driving rotor 266 to the driven rotor 268. Each of the rotors 266 and 268 comprises two first conveying stages 278 adjacent to either the upper radial bearing flange 232 which defines a portion of the upper bearing housing 231, or the lower radial bearing flange 234 which defines a portion of the lower bearing housing 233 (See FIG. 6). In addition, each of the rotors 266 and 268 comprises two second conveying stages 276 adjacent to the first conveying stages 278.

In one embodiment, the first conveying stage 278 and the second conveying stage 276 are configured as a threaded rotor. In one embodiment, the first conveying stage 278 and the second conveying stage 276 are configured as a threaded rotor as shown in FIG. 5. In one embodiment, the rotors 266 and 268 comprise screw threads that are characterized by a flip angle. In one embodiment, the first conveying stage 278 comprises screw threads oriented in a first sense having a first flip angle 510 and the second conveying stage 276 comprises screw threads oriented in a sense opposite to the first sense having a second flip angle 512. The term “sense” as used herein may be defined as the “handedness” of the threaded screw. In certain embodiments, the flip angle of the threads in the first conveying stage and the second conveying stage are aligned opposite to each other, such that the first conveying stage and the second conveying stage convey the process fluid in opposite directions. In an alternate embodiment, the flip angle of the threads of the first conveying stage and the second conveying stage are such that both the first conveying stage and the second conveying stage move the process fluid in contact with the threads in the same direction. In one embodiment, the first conveying stage and the second conveying stage comprise wavelike profilings. The wavelike profilings of the first conveying stage and the second conveying stage may be configured to convey a process fluid in opposite directions or same direction. Where the rotor comprises wavelike profilings in the first conveying stage, said profilings are configured to convey the fluid away from the bearing housing and toward a fluid outlet of the pump liner.

In one embodiment, the present invention provides a pump system comprising a threaded rotor having a first conveying stage and a second conveying stage, wherein the first conveying stage 278 comprises threads oriented to convey fluid in a first direction and the second conveying stage 276 comprises threads oriented to convey a process fluid in a second direction opposite that of the first direction._{[0]} Typically, adjacent threads on adjacent rotors of a twin screw pump have opposite thread configurations (sometimes referred to as “handedness”) to allow intermeshing and rotation of the rotors. Typically, the two rotors of a twin screw pump turn in opposite directions. The thread handedness of a second conveying stage 276, such as that shown in FIG. 6, may be such that the process fluid is transported inwardly from inlet chambers 216 and 218 to a center outlet chamber 224 (forward flow design). Alternatively, the thread handedness of a second conveying stage 276 may be such that the flow of process fluid is directed from one or more fluid inlet chambers outwardly toward fluid outlet chambers (reverse flow design) positioned nearer the ends of the rotor. In FIG. 6, such a reverse flow design would be achieved if element 224 indicated a fluid inlet chamber and elements 216 and 218 indicated fluid outlet chambers. For convenience, those portions of the rotors in direct fluid communication with a pump inlet chamber or a pump outlet chamber of the pump system are referred to by the same name (i.e. a pump inlet chamber or a pump outlet chamber). As noted, the threads 278 are always configured to convey a process fluid away from the bearing housings 231 and 233.

In one embodiment, the inlet 212 (See FIGS. 2 and 3) is configured such that the process fluid entering the fluid conduit defined by the pump liner 270 through the fluid inlet 212 first encounters the first conveying stage 278 before encountering the second conveying stage 276. In another embodiment, the inlet 212 is configured such that the process fluid entering the fluid conduit defined by the pump liner 270 through the fluid inlet 212 first encounters the second conveying stage 276 before encountering the first conveying stage 278. The first conveying stage 278, as mentioned above is configured to drive the process fluid away from the bearing housing. In this manner, the first conveying stage 278 performs a dynamic sealing function as the rotor turns, and thereby inhibits process fluid within the fluid conduit defined by the pump liner from entering the bearing housing. Typically, as discussed herein, mechanical seals must be deployed between the fluid conduit defined by the pump liner and the bearing housing to prevent process fluid from leaking into the bearing housing. In one aspect, the dynamic seal created by the configuration of the first conveying stage eliminates or minimizes the need for a mechanical seal.

FIG. 6 is a detailed three-dimensional perspective view 600 of an embodiment of the present invention configured for use in a twin-screw pump 200. As depicted, driving rotor 266 and driven rotor 268 are intermeshing and comprise conveying elements (threads) configured to convey a process fluid from the rotor portions designated inlet chambers 216 and 218 (See also FIG. 2) to a rotor portion designated outlet chamber 224, located near the center of the rotors. Those of ordinary skill in the art will understand that the pump inlet and outlet chambers may be separated from the rotors by the pump liner which comprises a fluid inlet and a fluid outlet allowing direct fluid communication between a portion of the rotor and either a pump inlet chamber or a pump outlet chamber. As shown in FIG. 6, both the inlet chambers 216 and 218 and the outlet chamber 224 constitute part of the first rotor portion disposed within the fluid conduit defined by the pump liner. A second rotor portion is disposed within a bearing housing defined in part by either upper radial bearing flange 232 or lower radial bearing flange 234. FIG. 6 is partially exploded in the sense that the gap shown between the upper radial bearing flange 232 and the first conveying stage 278 is highly exaggerated. In certain embodiments, when fully assembled, the gap between the upper radial bearing flange 232 and the first conveying stage 278 is made as small as possible, in some embodiments on the order of a few thousandths on an inch. FIG. 6 illustrates the relationship of the timing gears 258 and timing gear plate 262 to lower radial bearing flange 234. Also indicated are the hypothetical locations of the upper bearing housing 231 and lower bearing housing 233 in a pump system provided by the present invention. As depicted, the bearing flanges 232 and 234 are configured to support and enable rotation of the rotors 266 and 268. The rotors 266 and 268 include a first conveying stage 278 adjacent to each of the bearing flanges 232 and 234 and two second conveying stages 276 adjacent to the first conveying stages 278. It should be pointed out that the first conveying stage 278 adjacent to lower radial bearing flange 234 is not visible in FIG. 6.

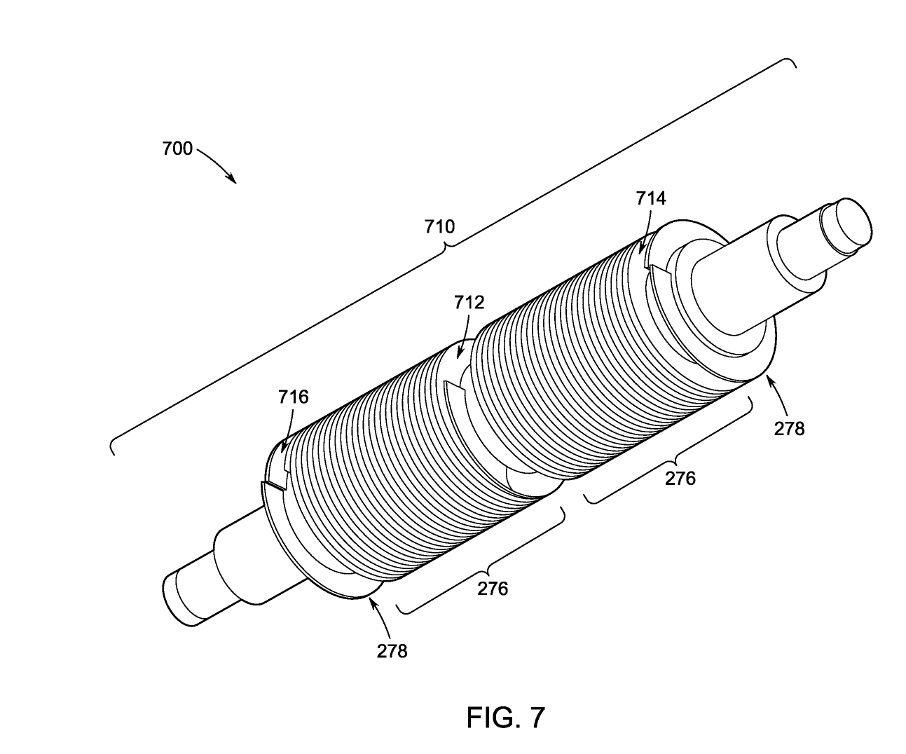

In one embodiment, the rotor is comprised of a single undivided shaft. As used herein the phrase “single undivided shaft” means that the entire shaft comprises a single entity and there are no joints in the shaft. Referring to FIG. 7, a rotor 700 in accordance with an embodiment of the invention is shown. The entire length 710 of the rotor 700 may be fabricated using a single material with no joints. In one embodiment, the single undivided shaft comprising the rotor may comprise steel, silicon carbide, or tungsten carbide. In certain embodiments, the steel may be coated with silicon carbide, tungsten carbide, or a combination thereof, to minimize corrosion or provide one or more desirable performance characteristics. In one embodiment, the rotor 700 includes two first conveying stages 278 located at opposite ends of the first rotor portion. First conveying stages 278 are disposed adjacent to a bearing housing in an assembled pump system provided by the present invention. The second conveying stages 276 are located between the two first conveying stages 278. A gap 712 is disposed between the two second conveying stages 276 and constitutes at least a portion of the outlet chamber in an assembled pump system provided by the present invention. In one embodiment, the gap 712 is aligned to the fluid outlet 226 of a pump system provided by the present invention. In one embodiment, gaps 714 and 716 are present between the first conveying stages 278 and the second conveying stages 276. In one embodiment, the gaps 714 and 716 are aligned to the fluid inlets 212 of a pump system provided by the present invention.

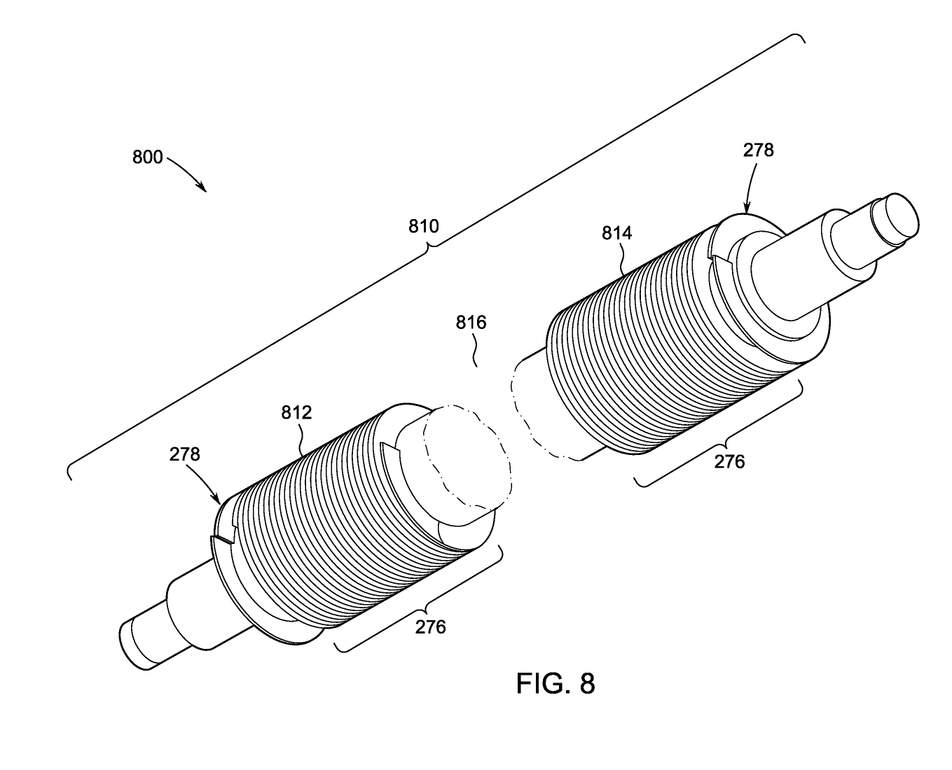

In an alternate embodiment, the rotor is comprised of a divided shaft. As used herein the phrase “comprised of a divided shaft” means that the rotor consists of multiple constituent pieces joined together to form a rotor. In one embodiment, the rotor may be made of two pieces. Referring to FIG. 8, a rotor 800 in accordance with an embodiment of the invention is shown. The rotor 800 having length 810 comprises two portions 812 and 814 joined together by a joint 816 at the centre. Each of the joined rotor portions 812 and 814 comprises a first conveying stage 278 and a second conveying stage 276.

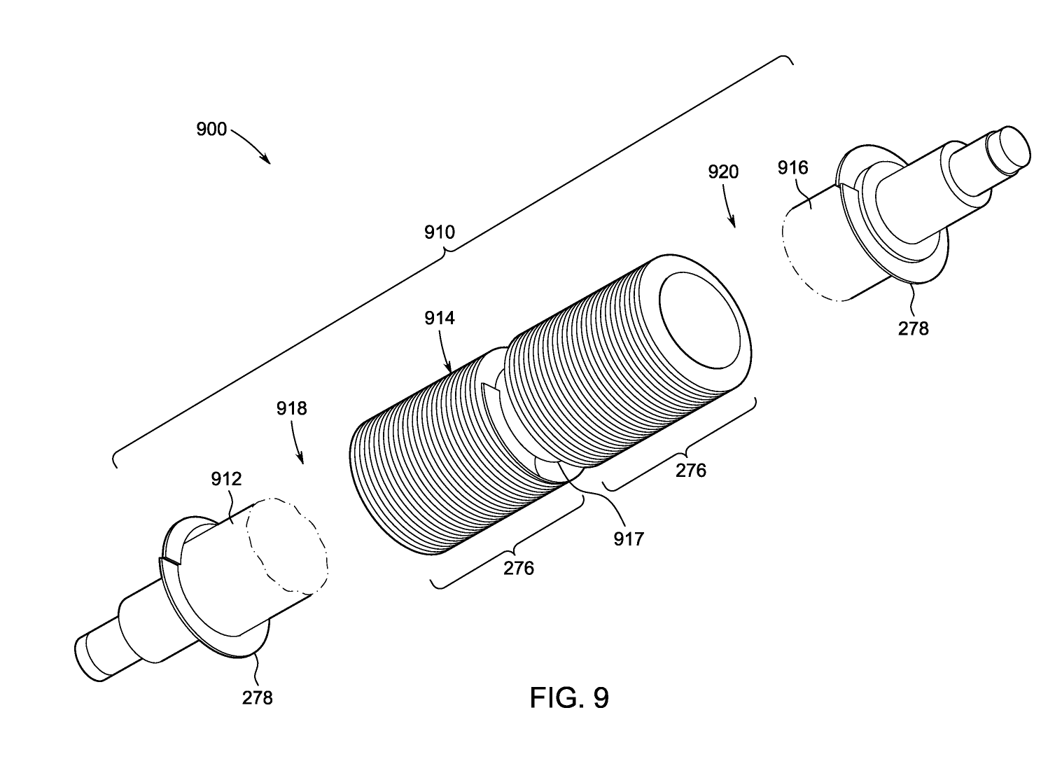

In one embodiment, the rotor may be made of three or more sections. Referring to FIG. 9, a rotor 900 in accordance with an embodiment of the invention is shown. The rotor 900 having length 910 comprises three rotor component sections 912, 914 and 916 and two joints 918 and 920. In the embodiment shown in FIG. 9, rotor sections 912 and 916 constitute the ends of the rotor, and each comprises a first conveying stage 278 which is disposed adjacent to a bearing housing in an assembled pump system provided by the present invention, and conveys fluid away from the bearing housing toward a fluid outlet. The central section 914 of the rotor comprises two second conveying stages 276 which are configured to convey a process fluid toward gap 917 in a pump system comprising a rotor 900 provided by the present invention.

In various embodiments, components of the pump system provided by the present invention, for example the bearing housing, the pump liner, and the rotor may comprise steel, silicon carbide, tungsten carbide, or a combination thereof. In one embodiment, at least one component of the pump system provided by the present invention, for example the first conveying stage comprises at least one material selected from the group consisting of steel, silicon carbide, tungsten carbide, and ceramics. In certain embodiments, the rotor comprises an abrasion resistant coating. In certain embodiments, a pump system component comprising steel may be coated with a corrosion resistant material, for example a silicon carbide coating or a tungsten carbide coating.

As is evident from this disclosure, an effective dynamic seal between a bearing housing and fluid conduit in a pump system provided by the present invention may be created by a relatively small first conveying stage. For convenience, the size of a conveying stage is framed in terms of the number of turns about the rotor a conveying element makes within the conveying stage. In one embodiment, the present invention provides a pump system comprising a first conveying stage 278 which comprises at least two turns of a conveying element, for example a rotor thread, about the rotor shaft. Typically, the second conveying stage 276 of pump systems provided by the present invention comprises a larger number of turns of the conveying element about the rotor shaft than does the first conveying stage. In one embodiment, the conveying elements of the second conveying stage 276 are configured as screw threads. It is believed that with the aid of this disclosure, those of ordinary skill in the art will be able to select suitable conveying element configurations for both the first conveying stage and the second conveying stage without undue experimentation, based on the functional requirements of the rotors 266 and 268 in the application at hand.

As previously discussed, the pump system provided by the present invention may be configured to direct process fluid to a separator and then direct treated process fluid back to components of the pump system requiring lubrication and/or dilution. In this manner, treated process fluid may be used to lubricate, for example, pump bearings, and to enhance process fluid flow and behavior within the fluid conduit defined by the pump liner. In one embodiment, the bearing housing comprises a plurality of bearings which are configured to be lubricated by the treated process fluid.

In another embodiment, the present invention provides a method of manufacture comprising providing a bearing housing coupled to a pump liner, the pump liner defining a fluid conduit, the pump liner comprising a fluid inlet and a fluid outlet; and disposing at least one rotor having a first rotor portion and a second rotor portion within the fluid conduit and the bearing housing such that the first rotor portion is disposed within the fluid conduit and the second rotor portion is disposed within the bearing housing; wherein the first rotor portion comprises a first conveying stage adjacent to the bearing housing, and a second conveying stage adjacent to the first conveying stage, the first and second conveying stages being configured to convey a fluid, the first conveying stage being configured to convey a fluid from the bearing housing into the fluid conduit.

In yet another embodiment, the present invention provides a method of pumping a fluid comprising introducing a process fluid into a pump system via a fluid inlet of the pump system and removing the process fluid from a fluid outlet of the pump system, said pump system comprising a bearing housing coupled to a pump liner, the pump liner defining a fluid conduit, the pump liner comprising a fluid inlet and a fluid outlet; and at least one rotor having a first rotor portion and a second rotor portion, the first rotor portion being disposed within the fluid conduit and the second rotor portion being disposed within the bearing housing; the first rotor portion comprising a first conveying stage adjacent to the bearing housing, and a second conveying stage adjacent to the first conveying stage, the first and second conveying stages being configured to convey a fluid, the first conveying stage being configured to convey a fluid from the bearing housing into the fluid conduit.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A pump system comprising:
a bearing housing coupled to a pump liner, the pump liner defining a fluid conduit, the pump liner comprising a fluid inlet and a fluid outlet; and
at least one rotor having a first rotor portion and a second rotor portion, the first rotor portion being disposed within the fluid conduit and the second rotor portion being disposed within the bearing housing;
the first rotor portion comprising a first conveying stage adjacent to the bearing housing, and a second conveying stage adjacent to the first conveying stage, the first and second conveying stages being configured to convey a fluid, the first conveying stage being configured to convey the fluid from the bearing housing into the fluid conduit.

2. The pump system according to claim 1, wherein the first and second conveying stages are configured to convey a fluid in opposite directions.

3. The pump system according to claim 1, wherein the first and second conveying stages are configured to convey a fluid in the same direction.

4. The pump system of claim 1 comprising a plurality of rotors.

5. The pump system of claim 1, wherein a clearance between the rotor and an inner surface of the pump liner is in a range from about 5 thousandths of an inch to about 10 thousandths of an inch.

6. The pump system of claim 1, wherein the rotor is comprised of a single undivided shaft.

7. The pump system of claim 1, wherein the rotor is comprised of a divided shaft.

8. The pump system of claim 1, wherein at least a portion of the rotor comprises steel, silicon carbide, or tungsten carbide.

9. The pump system of claim 1, wherein the first conveying stage and the second conveying stage are configured as a threaded shaft.

10. The pump system of claim 9, wherein a clearance between the threaded shaft and an inner surface of the pump liner is in a range from about 5 thousandths of an inch to about 10 thousandths of an inch.

11. The pump system of claim 9, wherein the threaded shaft comprises screw threads characterized by a flip angle.

12. The pump system of claim 9, wherein the first conveying stage comprises screw threads oriented in a first sense and the second conveying stage comprises screw threads oriented in a sense opposite to the first sense.

13. The pump system of claim 1, comprising a pump fluid inlet which is configured to produce a tangential flow of a process fluid within a pump inlet chamber.

14. The pump system of claim 1, wherein the fluid inlet is configured such that a process fluid entering the fluid conduit through said fluid inlet first encounters the first conveying stage before encountering the second conveying stage.

15. The pump system of claim 1, wherein the fluid inlet is configured such that a process fluid entering the fluid conduit through said fluid inlet first encounters the second conveying stage before encountering the first conveying stage.

16. The pump system of claim 1, wherein the first conveying stage comprises a conveying element making at least two turns about the rotor shaft.

17. The pump system of claim 1, wherein the first conveying stage and the second conveying stage comprise wavelike profilings.

18. The pump system of claim 17, wherein the wavelike profilings of the first conveying stage and the second conveying stage are configured to convey a fluid in opposite directions.

19. The pump system of claim 1, wherein the bearing housing comprises a plurality of bearings which are configured to be lubricated by a process fluid being pumped by the pump system.

20. The pump system of claim 1, wherein said rotor comprises an abrasion resistant coating.

21. A method of manufacture comprising:
providing a bearing housing coupled to a pump liner, the pump liner defining a fluid conduit, the pump liner comprising a fluid inlet and a fluid outlet; and
disposing at least one rotor having a first rotor portion and a second rotor portion within the fluid conduit and the bearing housing such that the first rotor portion is disposed within the fluid conduit and the second rotor portion is disposed within the bearing housing;
wherein the first rotor portion comprises a first conveying stage adjacent to the bearing housing, and a second conveying stage adjacent to the first conveying stage, the first and second conveying stages being configured to convey a fluid, the first conveying stage being configured to convey a fluid from the bearing housing into the fluid conduit.

22. The method of manufacture according to claim 21, wherein the first and second conveying stages are configured to convey a fluid in opposite directions.

23. The method of manufacture according to claim 21, wherein the first and second conveying stages are configured to convey a fluid in the same direction.

24. A method of pumping a fluid comprising:
introducing a process fluid into a pump system via a fluid inlet of the pump system and removing the process fluid from a fluid outlet of the pump system,
the pump system comprising a bearing housing coupled to a pump liner, the pump liner defining a fluid conduit, the pump liner comprising the fluid inlet and the fluid outlet; and at least one rotor having a first rotor portion and a second rotor portion, the first rotor portion being disposed within the fluid conduit and the second rotor portion being disposed within the bearing housing;
the first rotor portion comprising a first conveying stage adjacent to the bearing housing, and a second conveying stage adjacent to the first conveying stage, the first and second conveying stages being configured to convey a fluid, the first conveying stage being configured to convey a fluid from the bearing housing into the fluid conduit.

25. The method of pumping a fluid according to claim 24, wherein the process fluid is a multiphase fluid comprising solid, liquid, and gaseous components.
